(19) United States
(12) Patent Application Publication
(10) Pub. No.: US 2009/0133975 A1
(43) Pub. Date: May 28, 2009

(54) Vehicle Brake, In Particular Caliper Brake

(76) Inventor: Leo Gilles, Koblenz (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/992,570

(22) PCT Filed: Sep. 27, 2006
(86) PCT No.: PCT/EP2006/009408

§ 371 Date: Mar. 25, 2008

(30) Foreign Application Priority Data
Sep. 27, 2005 (DE) 10 2005 046 140.9

(51) Int. Cl. F16D 65/16

(52) U.S. Cl. 188/72.6

(57) ABSTRACT

The invention relates to a vehicle brake, in particular a caliper brake, having a housing, a brake piston accommodated in and linearly displaceable relative to the housing for displacing a brake lining, and a mechanical actuator arrangement for displacing the brake piston, wherein the brake piston is displaceable in the housing by charging a hydraulic chamber by means of a hydraulic brake circuit and wherein the mechanical actuator arrangement comprises a threaded spindle, which is mounted rotatably in the housing and may be set in rotation, wherein the brake piston as a result of a rotational movement of the threaded spindle is linearly displaceable relative to the housing. In this vehicle brake, it is provided that the threaded spindle is provided with a multiple-start self-locking thread having n flights, wherein the number n and the thread lead are selected in such a way that the thread is close to the self-locking limit.

### CROSS-REFERENCE TO RELATED APPLICATIONS

This application is a National Stage of International Application No. PCT/EP2006/009408 filed Sep. 27, 2006, the disclosures of which are incorporated herein by reference in their entirety, and which claimed priority to German Patent Application No. 10 2005 046 140.9 filed Sep. 27, 2005, the disclosures of which are incorporated herein by reference in their entirety.

### BACKGROUND OF THE INVENTION

The present invention relates to a vehicle brake, in particular to a caliper brake, having a housing, a brake piston accommodated in and linearly displaceable relative to the housing for displacing a brake lining, and a mechanical actuator arrangement for displacing the brake piston, wherein the brake piston is displaceable in the housing by charging a hydraulic chamber by means of a hydraulic brake circuit and wherein the mechanical actuator arrangement comprises a threaded spindle, which is rotatably mounted in the housing and may be set in rotation, wherein the brake piston as a result of a rotational movement of the threaded spindle is linearly displaceable relative to the housing. Such a brake is known for example from the document WO 2005/073043 A1, and corresponding U.S. Patent No. 2006/0267402 A1, both of which are incorporated herein by reference in their entirety. In such a vehicle brake, during a service braking operation the brake piston is displaced inside the housing by charging the hydraulic chamber with hydraulic fluid in order thereby to move a brake lining towards a brake disk and achieve a braking effect. To achieve a parking braking effect, the threaded spindle is set in rotation so that the brake piston is mechanically displaced or at least arrested. Particularly when high parking brake forces are to be achieved, a powerful rotary spindle drive has to be provided, which leads to a cost-intensive design. In order to counteract this problem, an idea that has already been considered in the previously cited prior art is to initiate the parking brake operation by first hydraulically displacing the brake piston and then, while provisionally maintaining the hydraulic pressure, setting the threaded spindle in rotation. In other words, in this prior art it is provided that, when the parking brake system for specific operating states has to sustain brake forces that are higher than the brake forces that it itself is capable of generating, the service brake system generates the additionally required brake forces. It has however emerged that, with conventional vehicle brakes, particularly the process of applying but also the process of releasing the brake takes a relatively large amount of time. In particular, the time taken to release the parking brake is found to be a nuisance because the driver has the same expectation as he has of mechanical parking brakes, namely that the parking brake will be released immediately after actuation of a brake switch. Longer time delays, which adversely affect for example a drive-away operation, are therefore to be avoided. The prior art cited above however provides that, particularly in the case of high parking brake forces, there is even additional need for hydraulic assistance to release the parking brake, because the motorized drive of the parking brake as a rule is not powerful enough to overcome the self-locking effect caused by the parking brake forces.

### BRIEF SUMMARY OF THE INVENTION

A feature of the present invention is to provide a vehicle brake of the initially described type, which, while being of a simple and hence inexpensive construction, provides rapid realization and in particular release of the parking brake state.

This feature is achieved by a vehicle brake of the initially described type, in which it is provided that the threaded spindle is provided with a self-locking thread having n flights, wherein the number n and the thread lead are selected in such a way that the thread is close to the self-locking limit. The use of a threaded spindle with a self-locking thread and a large lead at first seems counterproductive to the requirement for a low-power and hence inexpensively designed motorized drive. For the rule is namely that, given a constant clamping force (for example 15 Kn), the necessary torque (and hence the necessary motor output) rises if the spindle lead is increased. If, however, when effecting the parking brake operation the substantial displacement of the brake piston is effected hydraulically, so that the threaded spindle merely has to be displaced, substantially without opposed force, into an arresting position, then it is also possible to use a low-power drive for the threaded spindle because by means of the threaded spindle as such no application, or only a slight application of the brake piston occurs. Furthermore, the release of the parking brake state by means of a threaded spindle designed with a larger lead is considerably easier because in this way the self-locking may be overcome more easily.

When the term “threaded spindle” is used in connection with the description of this invention, this term means that the threaded spindle may be provided within the framework of a simple nut-and-spindle arrangement. Equally, however, this term also includes applications where the threaded spindle is disposed within a ball spindle drive (also known as a ball-and-screw spindle drive) or within a planetary rolling threaded-spindle arrangement or within a ramp arrangement. All of the applications of the invention that are mentioned are simultaneously covered by the wording of the claims.

Any desired number of flights or any desired size of leads may be provided. The governing factor is however that the thread is still of a self-locking design, because otherwise the parking brake state cannot be maintained.

According to the invention, it may be provided that the brake piston with the housing encloses the hydraulic chamber. It may further be provided that the brake piston during a service braking operation is hydraulically displaceable and that the brake piston during a parking braking operation is arrestable in a parking brake position by means of the threaded spindle. The threaded spindle in the parking brake state therefore acts as part of a strut, via which the brake piston is supported against the housing so that the application force may be maintained. A development of the invention provides that the threaded spindle interacts thread-wise with a nut arrangement that is preferably accommodated in the brake piston. In this connection, it may also be provided that the brake piston in the parking brake state is supported on the nut arrangement, which is therefore supported in a self-locking manner on the threaded spindle.

As has already been mentioned above, according to the invention it may be provided that, for realizing an, in particular, high parking brake force, the brake piston is displaceable by charging the hydraulic chamber and in the displaced state the nut arrangement is displaceable into a blocking position by means of the threaded spindle. It may further be provided that, for cancelling the parking braking effect, the brake piston by driving the threaded spindle or the nut arrangement is displaceable out of the blocking position. This is particularly easy because of the large thread lead. Additional hydraulic assistance is therefore no longer required for cancelling the parking brake state.

It may preferably be provided that the threaded spindle may be motor-driven, for example via a gear arrangement having a gear ratio tuned to the spindle lead, in particular a planetary gear arrangement. As a result of this measure it is also possible to use a motor of a low-power design that has a correspondingly low power consumption. Because of the low power consumption, the motor control unit may be integrated into a control unit of the hydraulic system.

As regards the design of the multiple-start thread, according to the invention it may be provided that n is in the region of 1 to 4, preferably in the region of 2. According to the invention, it may further be provided that the thread lead is in the region of 1 to 5 mm, preferably approximately 2.5 mm.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a section through a vehicle brake according to the invention;

FIG. 2 is a detail representation of the threaded spindle arrangement;

FIG. 3 illustrates different diagrams relating to the operation of the vehicle brake according to the invention.

### DETAILED DESCRIPTION OF THE INVENTION

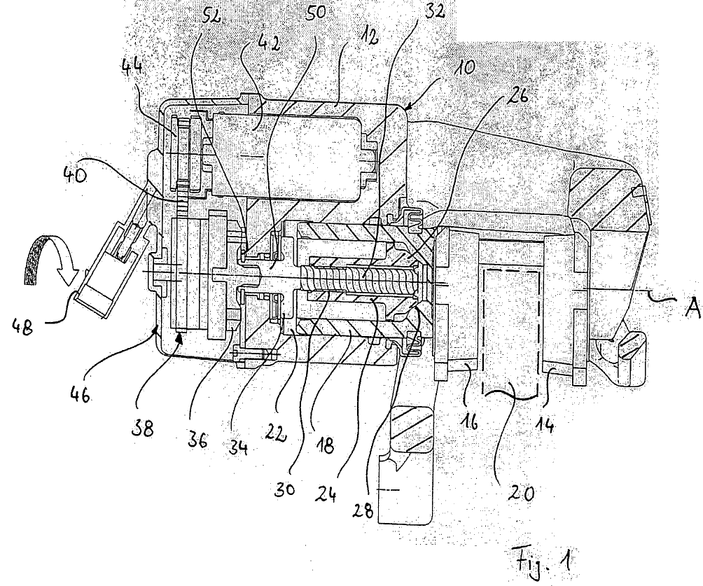

In FIG. 1 a vehicle brake according to the invention is denoted generally by 10. The vehicle brake 10 takes the form of a caliper brake. It comprises a housing 12, in which two brake linings 14 and 16 are accommodated in accordance with the floating caliper principle. The brake lining 16 is displaceable by means of a brake piston 18 along an axis A towards a brake disk 20, which is indicated merely by a dashed line.

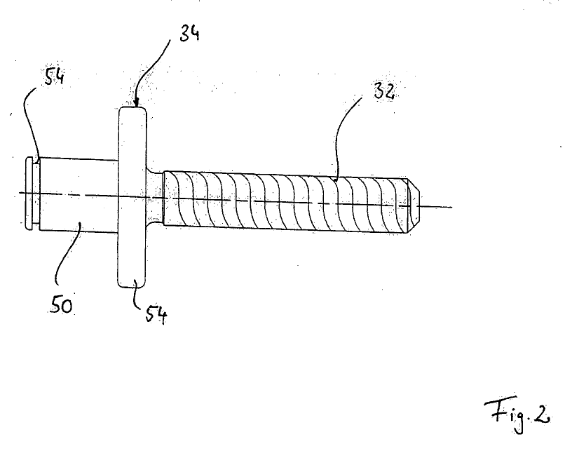

The brake piston 18 with the housing 12 encloses a hydraulic chamber 22. The brake piston 18 is of a hollow design. Accommodated in the brake piston 18 is a nut arrangement 24, which has a conical head portion 26. The conical head portion 26 may be brought into blocking engagement with a conical portion 28 of a complementary design in the interior of the brake piston 18. The nut arrangement 24 is moreover accommodated in a rotationally fixed manner in the linearly displaceable brake piston 18. The nut arrangement 24 is likewise of a hollow design and is provided with a threaded portion 30. Accommodated in the threaded portion 30 is a threaded spindle 32, which is in thread-wise engagement with the threaded portion 30. The threaded spindle 32 is part of a spindle component 34 that is shown in a detail representation in FIG. 2. The spindle component 34 is connected in a rotationally fixed manner to a gear output element 36 of a planetary gear arrangement 38. The planetary gear arrangement 38 has a gear ratio adapted to the spindle lead and is drivable via a mechanism, preferably with a driving toothed belt 40, by an electric motor 42. The planetary gear arrangement 38 as well as the toothed belt and the output shaft of the electric motor 42, on which an output gear wheel 44 is seated, are disposed in a housing portion 46. The housing portion 46 further comprises an electric central connector 48. The spindle component 34 is mounted by means of a journal portion 50 rotatably in the housing 12 and is supported in axial direction via a safety ring 52 against the housing 12. The safety ring 52 is disposed in a circumferential recess 54.

The threaded spindle 32 of the spindle component 34 is of a multiple-start design, i.e. it comprises a plurality of flights. In the example, the threaded spindle is of a double-threaded design with a thread lead of p=2.5 mm. This guarantees, on the one hand, that the thread pairing of the external thread of the threaded spindle 32 and the threaded portion 30 is self-locking, i.e. positionally stable, under axial load and, on the other hand, that by a relatively low number of revolutions of the spindle component 34 relatively high adjusting strokes of the nut arrangement 24 may be achieved. It should be noted that the self-locking depends on a large number of factors, in particular on the effective diameter/spindle diameter, the material pairing, temperature, lubrication and manufacture-related factors such as for example the surface roughness, so that given the least favourable composition of these factors, i.e. even with low friction (high surface quality, low coefficient of friction) self-locking is guaranteed.

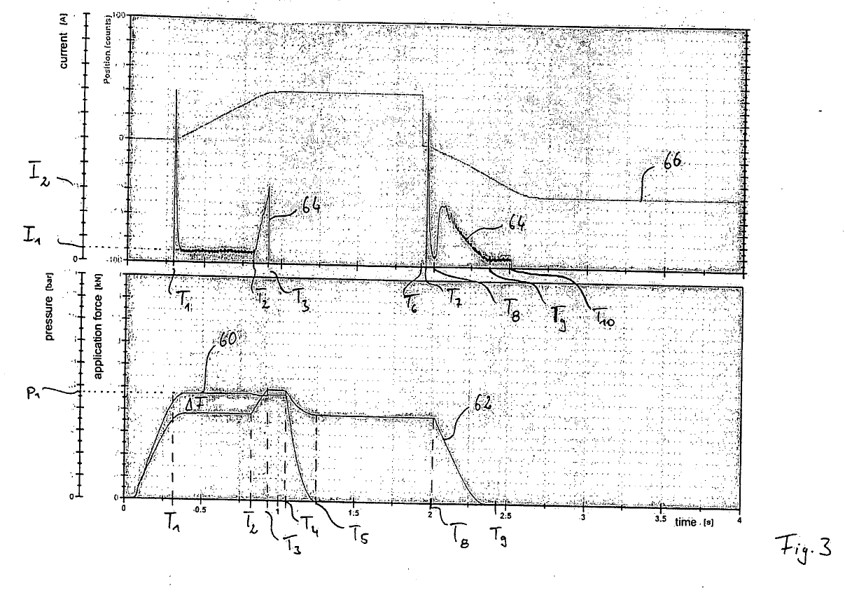

There now follows a description of the mode of operation of the vehicle brake according to the invention with reference to FIG. 3.

During a service braking operation, i.e. when a driver would like to decelerate a vehicle equipped with the vehicle brake according to the invention, the brake piston and hence the brake lining 16 are hydraulically displaced by charging the hydraulic chamber 22 with hydraulic fluid by means of a hydraulic system (not shown). The hydraulic system preferably comprises active components, i.e. a pump or the like of an electrically controllable service brake system, which in addition to an anti-locking control function allows braking functions that are independent of a driver actuation, i.e. automatic braking functions, such as for example traction control (ASR) or an electronic stability program (ESP). For this purpose, the brake system comprises a conventionally equipped electrohydraulic control unit, an electronically controllable brake booster or takes the form of a so-called “brake-by-wire” system. In other words, this means that the hydraulic chamber 22 may be charged with hydraulic fluid independently of a brake pedal actuation.

In the case of activation of the parking brake, the driver actuates for example a switch in the vehicle. This occurs at the time T=0 seconds. As a result, first the hydraulic chamber 22 is charged with hydraulic fluid, as curve 60 in the bottom diagram of FIG. 3 shows. The hydraulic pressure rises from the value 0 bar to a value P1 that lies in the region of for example 60 bar to 160 bar. Together with the hydraulic pressure, the application force at the brake lining 26 also rises, as shown by curve 62. At the time T1, for example on attainment of a specific pressure or a specific application force, the motor 42 is activated. This is shown by curve 64, which reflects the motor current. Curve 66 reflects the spindle position.

At the time T1 a current peak may be seen. This results from the overcoming of static friction and inertia effects in the mechanical system (gear 38 etc.) in accordance with the vehicle brake according to FIG. 1. Following the current peak, the motor current is at the value I1 in the region of 0.5 A to 5 A and remains substantially constant up to the time T2. During this period (T1 to T2) the nut arrangement 24 tracks the brake piston 18, which has already been biased into a provisional parking brake position. At the time T2 the nut arrangement 24 comes with its conical portion 26 into contact with the conical portion 28 of the brake piston 18. From time T2 to time T3 the brake piston 18 is applied further by means of the motor 42 via the gear 38, the spindle component 34 and the nut arrangement 24. The result is an application force increase of ΔF, as is shown in the bottom diagram of FIG. 3. Because of the increasing application force a rise of the motor current (curve 64) also occurs up to the time T3. After attainment of a specific motor current I₂ (for example up to 10 A), which in addition to the hydraulically achieved application force provides the additional auxiliary application force ΔF, the motor 42 is deactivated.

Because of the low power consumption, the motor control unit may be integrated into a control unit of the hydraulic system.

The hydraulic pressure in the hydraulic chamber 22 is still maintained up to the time T4. Finally, at the time T4 the hydraulic pressure in the hydraulic chamber 22 is reduced until at the time T5 it reaches the value zero. Between the times T4 and T5 the application force at the brake lining 16 also decreases. This is the result of settling effects in the mechanical components of the vehicle brake 10. The hydraulic chamber 22 is therefore relieved of pressure at the time T5. The vehicle brake 10 is in its parking brake state, in which the brake piston 18 is mechanically blocked in its position by means of the spindle component 34 and the nut arrangement 24. The spindle component 34 in this case is supported by means of the flange 54, which is disposed between the threaded spindle 32 and the journal portion 50, against the housing 12.

If then at the time T6 the driver for example by means of a switch outputs a signal, according to which the parking brake state is to be cancelled, then the motor 42 is reactivated in the opposite direction. This leads initially at the time T7 to a further current peak, which, as already indicated above, results from an overcoming of static friction and inertia of the mechanical components. After idle motions and the like have been completed, the spindle component 34 is finally driven in the opposite direction to the application effect. The self-locking (static friction) of the thread pairing of the threaded spindle 32 and the nut arrangement 24 has to be overcome, which explains the rise of the motor current at the time T8. At the same time, there is a rapid reduction of the application force between the times T8 and T9, until finally the application force assumes the value zero. With decreasing application force, the motor current also drops, as curve 64 shows. Finally, the vehicle brake is in its initial position, as shown in FIG. 1. At the time T10 the motor 42 is deactivated. The parking brake state has now been completely cancelled.

Through the interaction of the spindle 32 according to the invention and a gear arrangement 38 tuned thereto the actuating time, in particular the release time, may be considerably shortened. In an example according to the invention, in which the threaded spindle instead of having a lead of one millimetre, as in a standard spindle, has a spindle lead of approximately 2.5 mm, it was possible to reduce the release time, i.e. the period between T8 and T9, to less than one second. With a conventional spindle lead of 1 mm, the release time is greater than 1 second.

Furthermore, with the selection according to the invention of the spindle lead and the gear ratio tuned thereto it is possible to reduce the release torque for releasing the parking brake state. The motor 42 may accordingly be of a less powerful, smaller and hence less expensive design. This is possible particularly because the parking brake state is brought about using the hydraulic system that is in any case provided. For release, on the other hand, because of the greater efficiency of the threaded spindle and the gear ratio tuned thereto (in the example approximately 0.35) no additional hydraulic assistance is required, unlike in the prior art. With the invention it has therefore been recognized that by selecting a spindle lead close to the self-locking limit and by suitably tuning the gear ratio it is possible to use a less powerful motor, while at the same time the actuating time, in particular the release time, and the release torque may be reduced.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. Vehicle brake comprising:
a housing;
a brake piston accommodated in and linearly displaceable relative to the housing for displacing a brake lining; and
a mechanical actuator arrangement for displacing the brake piston, wherein the brake piston is displaceable in the housing by charging a hydraulic chamber by means of a hydraulic brake circuit and wherein the mechanical actuator arrangement comprises a threaded spindle, which is mounted rotatably in the housing and may be set in rotation, wherein the brake piston as a result of a rotational movement of the threaded spindle is linearly displaceable relative to the housing, wherein the threaded spindle is provided with a self-locking thread having n flights, wherein the number n and a thread lead are selected in such a way that the thread is close to a self-locking limit.

2. Vehicle brake according to claim 1, wherein the brake piston with the housing encloses the hydraulic chamber.

3. Vehicle brake according to claim 1 wherein the brake piston in a service brake state is hydraulically displaceable and that the brake piston in a parking brake state is arrestable in a parking brake position by means of the threaded spindle.

4. Vehicle brake according to claim 1, wherein the threaded spindle interacts thread-wise with a nut arrangement that is accommodated in the brake piston.

5. Vehicle brake according to claim 5, the brake piston in the parking brake state is supported on the nut arrangement, which is therefore supported in a self-locking manner on the threaded spindle.

6. Vehicle brake according to claim 5, wherein for realizing high parking brake force the brake piston is displaceable by charging the hydraulic chamber and in the displaced state the nut arrangement is displaceable into a blocking position by means of the threaded spindle.

7. Vehicle brake according to claim 5, wherein for cancelling the parking brake effect the brake piston by driving the threaded spindle or the nut arrangement is displaceable out of the blocking position.

8. Vehicle brake according to claim 1, wherein the threaded spindle may be motor-driven via a gear arrangement tuned to the threaded spindle.

9. Vehicle brake according to claim 8, wherein a control unit of the motor drive may be integrated in a control unit of the hydraulic brake circuit.

10. Vehicle brake according to claim 1, wherein n is in the region of 1 to 4.

11. Vehicle brake according to claim 1, wherein the thread lead of the threaded spindle is in the region of 1 to 5 mm.

12. Method of actuating a vehicle brake according to claim 1, wherein, for realizing the parking brake state, initially the brake piston is displaced into a provisional parking brake position by charging the hydraulic chamber with hydraulic fluid, then the threaded spindle is set in rotation until the brake piston is biased into a predetermined parking brake position, and then the hydraulic chamber is hydraulically relieved, and wherein, for cancelling the parking brake state, only the threaded spindle is set in rotation without the hydraulic chamber being previously charged with hydraulic fluid.

13. Vehicle brake according to claim 8, wherein the gear arrangement is a planetary gear arrangement.

14. Vehicle brake according to claim 10, wherein n is 2.

15. Vehicle brake according to claim 11, wherein the thread lead of the threaded spindle is approximately 2.5 mm.
